(19) United States
(12) Patent Application Publication
(10) Pub. No.: US 2022/0164308 A1
(43) Pub. Date: May 26, 2022

(54) SYSTOLIC ARRAY PROCESSOR AND OPERATING METHOD OF SYSTOLIC ARRAY PROCESSOR

(71) Applicant: ELECTRONICS AND TELECOMMUNICATIONS RESEARCH INSTITUTE, Daejeon (KR)

(72) Inventors: Chun-Gi LYUH, Daejeon (KR); Min-Seok CHOI, Daejeon (KR); Young-Su KWON, Daejeon (KR); Jin Ho HAN, Daejeon (KR)

(73) Assignee: ELECTRONICS AND TELECOMMUNICATIONS RESEARCH INSTITUTE, Daejeon (KR)

(21) Appl. No.: 17/523,615

(22) Filed: Nov. 10, 2021

(30) Foreign Application Priority Data
Nov. 26, 2020 (KR) 10-2020-0161696
Sep. 15, 2021 (KR) 10-2021-0123095

(51) Int. Cl. G06F 15/80; G06F 9/54

(52) U.S. Cl. CPC G06F 15/8046; G06F 9/545

(57) ABSTRACT

Disclosed is a processor according to the present disclosure, which includes processing elements, a kernel data memory that provides a kernel data set to the processing elements, a data memory that provides an input data set to the processing elements, and a controller that provides commands to the processing elements, and a first processing element among the processing elements delays a first command received from the controller and first input data received from the data memory for a delay time, and then transfers the delayed first command and the delayed first input data to a second processing element, and the controller adjusts the delay time.

### CROSS-REFERENCE TO RELATED APPLICATIONS

This application claims priority under 35 U.S.C. § 119 to Korean Patent Application Nos. 10-2020-0161696, filed on Nov. 26, 2020, and 10-2021-0123095, filed on Sep. 15, 2021, respectively, in the Korean Intellectual Property Office, the disclosures of which are incorporated by reference herein in their entireties.

### BACKGROUND

Embodiments of the present disclosure described herein relate to an electronic device, and more particularly, relate to a systolic array processor that adaptively adjusts an operation scale in a fixed hardware structure, and an operating method of the systolic array processor.

Machine learning requires simple and repetitive operations. For the simple and repetitive operation, a GPU (Graphics Processing Unit) may be used. However, since the GPU is a device designed for graphics processing, not a device designed for machine learning, the GPU may have limitations in performing operations related to machine learning.

To overcome the limitations of GPUs, new processors optimized for machine learning are being studied. The processors implemented in hardware have advantages of being able to quickly perform operations related to machine learning. However, for the processors implemented in hardware, the size of an input, the size of an output, etc. should be determined at the time of designing the processors, and thus the flexibility is relatively small.

### SUMMARY

Embodiments of the present disclosure provide a systolic array processor having improved flexibility and a method of operating the systolic array processor.

According to an embodiment of the present disclosure, a processor includes processing elements, a kernel data memory that provides a kernel data set to the processing elements, a data memory that provides an input data set to the processing elements, and a controller that provides commands to the processing elements, and a first processing element among the processing elements delays a first command received from the controller and first input data received from the data memory for a delay time, and then transfers the delayed first command and the delayed first input data to a second processing element, and the controller adjusts the delay time.

According to an embodiment, the second processing element may delay the first command and the first input data received from the first processing element for the delay time, and then may transfer the delayed first command and the delayed first input data to a third processing element.

According to an embodiment, a fourth processing element of the processing elements may receive the first command from the first processing element, may receive second input data from the data memory, and may delay the first command and the second input data and then transfers the delayed first command and the delayed second input data to a fifth processing element.

According to an embodiment, the fifth processing element may delay the first command and the second input data received from the fourth processing element for the delay time, and then may transfer the delayed first command and the delayed second input data to a sixth processing element.

According to an embodiment, the kernel data memory may provide first kernel data to the first processing element, and may provide second kernel data to the second processing element after the delay time elapses.

According to an embodiment, the first command and the first input data may be transferred from the second processing element to a third processing element through at least one processing element, and the third processing element may perform an operation based on the first command and the first input data, and then may not transfer the first command and the first input data to another processing element.

According to an embodiment, the first processing element may delay a second command received from the controller and a second input data received from the data memory for the delay time, and then may transfer the delayed second command and the delayed second input data to the second processing element.

According to an embodiment, the first processing element may generate first output data by performing an operation based on the first command with respect to first kernel data received from the kernel data memory and the first input data, and may transfer the first output data to the data memory without delaying.

According to an embodiment, the second processing element may generate second output data by performing an operation based on the first command with respect to second kernel data received from the kernel data memory and the first input data, and may transfer the second output data to the first processing element without delaying.

According to an embodiment of the present disclosure, a method of operating a processor including a plurality of processing elements arranged in rows and columns includes identifying a length of input data, calculating a delay time based on the length of the input data and a length of a transmission path of the plurality of processing elements, and performing an operation while delaying the input data and kernel data by the delay time in at least some of the plurality of processing elements.

According to an embodiment, the identifying of the length of the input data may include identifying the number of processing elements required to process data input to processing elements in one row of the input data.

According to an embodiment, the length of the transmission path of the processing elements may be the number of processing elements arranged in one row of the plurality of processing elements.

According to an embodiment, when the number of processing elements required to process the data is greater than the number of processing elements arranged in the one row, the delay time may be 1 or more.

According to an embodiment, when the number of processing elements required to process the data is less than or equal to the number of processing elements arranged in the one row, the delay time may be ‘0’.

According to an embodiment, the delay time may be counted as the number of operation cycles of the plurality of processing elements.

### BRIEF DESCRIPTION OF THE FIGURES

The above and other objects and features of the present disclosure will become apparent by describing in detail embodiments thereof with reference to the accompanying drawings.

FIG. 1 illustrates a systolic array processor according to an embodiment of the present disclosure.

FIG. 2 illustrates a method of operating a processor according to an embodiment of the present disclosure.

FIG. 3 illustrates a first processing element according to an embodiment of the present disclosure.

FIG. 4 illustrates a second processing element according to an embodiment of the present disclosure.

FIG. 5 illustrates a third processing element according to an embodiment of the present disclosure.

FIGS. 6A, 6B and 6C illustrate examples in which processing elements operate when a delay time is zero.

FIGS. 7A, 7B, 7C, and 7D illustrate examples in which processing elements operate when a delay time is 1.

FIG. 8 illustrates an electronic device according to an embodiment of the present disclosure.

### DETAILED DESCRIPTION

Hereinafter, embodiments of the present disclosure will be described clearly and in detail such that those skilled in the art may easily carry out the present disclosure. Hereinafter, “and/or” should be construed to include any one of the items listed in association with the term, and a combination of some or all of the items listed in association with the term.

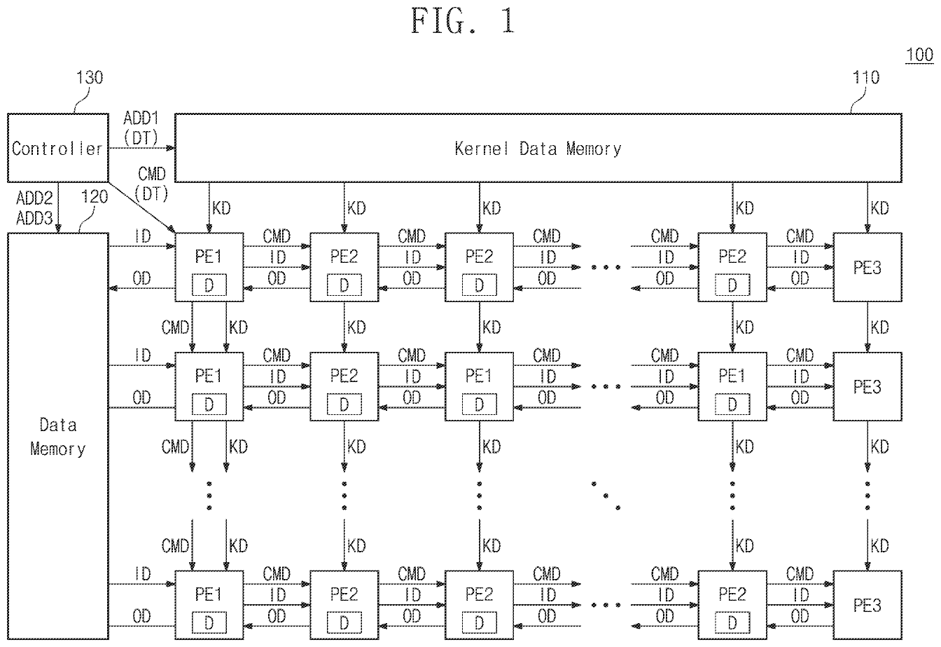

FIG. 1 illustrates a systolic array processor 100 according to an embodiment of the present disclosure. Referring to FIG. 1, the systolic array processor 100 may include a kernel data memory 110, a data memory 120, a controller 130, first processing elements PE1, second processing elements PE2, and third processing elements PE3.

The kernel data memory 110 may store kernel data (e.g., weight data) used as a kernel. In response to receiving a first address ADD1 from the controller 130, the kernel data memory 110 may provide kernel data KD to the first processing elements PE1, the second processing elements PE2, and the third processing elements PE3. For example, the kernel data memory 110 may provide kernel data stored in a storage space indicated by the first address ADD1.

For example, the kernel data memory 110 may provide the kernel data KD to the first processing element PE1 in a first row, the second processing element PE2 in the first row, and the third processing element PE3 in the first row. For example, the kernel data memory 110 may provide the kernel data KD, based on an order of columns of the processing elements PE1, PE2, and PE3.

The kernel data memory 110 may receive information of a delay time DT from the controller 130. The information of the delay time DT may be received together with the first address ADD1 or independently of the first address ADD1. The kernel data memory 110 may provide the kernel data KD to the first processing element PE1 in a first column, and may provide the kernel data KD to the second processing element PE2 in a second column after the delay time DT elapses.

The kernel data memory 110 may provide the kernel data KD to the second processing element PE2 in the second column, and may provide the kernel data KD to the second processing element PE2 in the third column after the delay time DT elapses. As in the above description, the kernel data memory 110 may provide the kernel data KD to the processing element PE1 or PE2 in a (k−1)-th column (‘k’ is a positive integer equal to or less than the number of columns of the processing elements PE1, PE2, and PE3), and may provide the kernel data KD to the processing elements PE2 or PE3 in a k-th column after the delay time DT elapses.

The data memory 120 may store input data and output data. In response to receiving a second address ADD2 from the controller 130, the data memory 120 may provide input data ID to the first processing elements PE1. For example, the data memory 120 may provide input data ID stored in a storage space indicated by the second address ADD2. In response to receiving a third address ADD3 from the controller 130, the data memory 120 may store output data OD transferred from the first processing elements PE1. For example, the data memory 120 may store the output data OD in a storage space indicated by the third address ADD3.

For example, the data memory 120 may provide the input data ID, based on the order of the rows of the first processing elements PE1. The data memory 120 may provide the input data ID to the first processing element PE1 in the first row, and may provide the input data ID to the first processing element PE1 in the second row after one operation cycle (e.g., an operation cycle of the processing elements PE1, PE2, or PE3) elapses.

The data memory 120 may provide the input data ID to the first processing element PE1 in the second row, and may provide the input data ID to the first processing element PE1 in the third row after one operation cycle elapses. As in the above description, the data memory 120 may provide the input data ID to the first processing element PE1 in an (m−1)-th row (′m′ is a positive integer and the number of rows of the processing elements PE1, PE2, and PE3), and may provide the input data ID to the first processing element PE1 in an m-th row after one operation cycle elapses.

The controller 130 may provide the first address ADD1 and information of the delay time DT to the kernel data memory 110. The controller 130 may provide the second address ADD2 and the third address ADD3 to the data memory 120. The controller 130 may provide a command CMD and information of the delay time DT to the first processing element PE1 in the first row and the first column. For example, the controller 130 may include information of the delay time DT in the command CMD, or may independently provide the command CMD and the information of the delay time DT to the first processing element PE1. Hereinafter, it is assumed that the information of the delay time DT is included in the command CMD.

The first processing elements PE1 may be arranged in a first column. The first processing element PE1 in the first row and the first column may receive the command CMD from the controller 130, may receive the kernel data KD from the kernel data memory 110, and may receive the input data ID from the data memory 120. The first processing element PE1 in the first row and the first column may generate the output data OD by performing an operation depending on the command CMD with respect to the kernel data KD and the input data ID. The first processing element PE1 in the first row and the first column may transfer the output data OD to the data memory 120. In addition, the first processing device PE1 in the first row and the first column may transfer the output data OD transferred from the second processing device PE2 in the first row and the second column to the data memory 120.

The first processing device PE1 in the first row and the first column may transfer the command CMD and the kernel data KD to the first processing element PE1 in the second row. The first processing element PE1 in the first row and the first column may include a delay element D. A delay amount of the delay element D may be set by information of the delay time DT. The first processing element PE1 in the first row and the first column may transfer the command CMD and the input data ID to the second processing element PE2 in the first row and the second column after the delay time DT elapses after the command CMD and the input data ID are input.

The delay time DT may be counted as the number of operation cycles of the processing elements PE1, PE2, and PE3. For example, the delay time DT may be ‘0’ or a positive integer greater than ‘0’. The delay time DT may be determined by the controller 130.

Each of the first processing elements PE1 in the second to m-th rows of the first column may receive the command CMD and the kernel data KD from the first processing element PE1 in a previous row. Each of the first processing elements PE1 in the second to m-th rows of the first column may receive input data ID from the data memory 120. Each of the first processing elements PE1 in the second to m-th rows of the first column performs an operation depending on the command CMD with respect to the kernel data KD and the input data ID to generate the output data OD.

Each of the first processing elements PE1 in the second to m-th rows of the first column may transfer the output data OD to the data memory 120. In addition, each of the first processing elements PE1 in the second to m-th rows of the first column may transfer the output data OD transferred from each corresponding second processing element PE2 in the same row in the second column to the data memory 120.

Each of the first processing elements PE1 in the second to (m−1)-th rows of the first column may transfer the command CMD and the kernel data KD to the first processing element PE1 in a subsequent row. Each of the first processing elements PE1 in the second to m-th rows of the first column may include the delay element D. A delay amount of the delay element D may be set based on information on the delay time DT. Each of the first processing elements PE1 in the second to m-th rows of the first column may transfer the command CMD and the input data ID to the second processing element PE2 in the second column after the command CMD and the input data ID are input and then the delay time DT elapses.

Each of the second processing elements PE2 in the first row may receive the command CMD and input data ID from the processing element PE1 or PE2 in the previous column. Each of the second processing elements PE2 in the first row may receive the kernel data KD from the kernel data memory 110.

Each of the second processing elements PE2 in the first row may generate the output data OD by performing an operation based on the command CMD with respect to the input data ID and the kernel data KD. Each of the second processing elements PE2 in the first row may transfer the output data OD to the processing element PE1 or PE2 in the previous column.

Each of the second processing elements PE2 in the first row may transfer the command CMD and the kernel data KD to the second processing elements PE2 in the subsequent row. Each of the second processing elements PE2 in the first row may include the delay element D. A delay amount of the delay element D may be set by the information of the delay time DT. Each of the second processing elements PE2 in the first row may transfer the command CMD and the input data ID to the processing element PE2 or PE3 in the subsequent column after the command CMD and the input data ID are input and then the delay time DT elapses.

Each of the second processing elements PE2 in the second to m-th rows may receive the command CMD and the input data ID from the processing element PE1 or PE2 in the previous column. Each of the second processing elements PE2 in the second to m-th rows may receive the kernel data KD from the second processing element PE2 in the previous row.

Each of the second processing elements PE2 in the second to m-th rows may generate the output data OD by performing an operation based on the command CMD with respect to the input data ID and the kernel data KD. Each of the second processing elements PE2 in the second to m-th rows may transfer the output data OD to the processing element PE1 or PE2 in the previous column.

Each of the second processing elements PE2 in the second to (m−1)-th rows may transfer the command CMD and the kernel data KD to the second processing element PE2 in the subsequent row. Each of the second processing elements PE2 in the second to m-th rows may include the delay element D. A delay amount of the delay element D may be set based on information on the delay time DT. After the delay time DT elapses after the command CMD and the input data ID are input, each of the second processing elements PE2 in the second to m-th rows may transfer the command CMD and the input data ID to the processing element PE2 or PE3 in the subsequent column.

The third processing element PE3 in the first row may receive the command CMD and the input data ID from the second processing element PE2 in the previous column. The third processing element PE3 in the first row may receive the kernel data KD from the kernel data memory 110.

The third processing element PE3 in the first row may generate the output data OD by performing an operation depending on the command CMD with respect to the input data ID and the kernel data KD. The third processing element PE3 in the first row may transfer the output data OD to the second processing element PE2 in the previous column. The third processing element PE3 in the first row may transfer the command CMD and the kernel data KD to the third processing element PE3 in the subsequent row.

Each of the third processing elements PE3 in the second to m-th rows may receive the command CMD and the input data ID from the second processing element PE2 in the previous column. Each of the third processing elements PE3 in the second to m-th rows may receive the kernel data KD from the third processing element PE3 in the previous row.

Each of the third processing elements PE3 in the second to m-th rows may perform an operation depending on the command CMD with respect to the input data ID and the kernel data KD to generate the output data OD. Each of the third processing elements PE3 in the second to m-th rows may transfer the output data OD to the second processing element PE2 in the previous column. Each of the third processing elements PE3 in the second to (m−1)-th rows may transfer the command CMD and the kernel data KD to the third processing element PE3 in the subsequent row.

The third processing elements PE3 are located farthest from the data memory 120 on the transmission paths of the processing elements PE1, PE2, and PE3, and thus do not need to transfer the command CMD and the input data ID. Accordingly, unlike the first processing elements PE1 and the second processing elements PE2, the third processing elements PE3 may not include the delay element D.

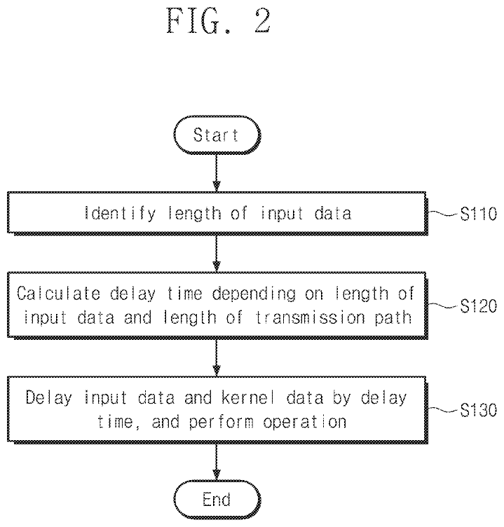

FIG. 2 illustrates a method of operating the processor 100 according to an embodiment of the present disclosure. Referring to FIGS. 1 and 2, in operation S110, the controller 130 of the processor 100 may identify a length of the input data. For example, the length of the input data may indicate the number of processing elements PE1, PE2, and PE3 required to process data input to the processing elements PE1, PE2, and PE3 of one row of the input data.

In operation S120, the controller 130 of the processor 100 may calculate the delay time DT depending on the length of the input data and the length of the transmission path. For example, the length of the transmission path may indicate the number of processing elements PE1, PE2, and PE3 arranged in one row.

When the length of the input data (e.g., the number of processing elements required to process the data) is greater than the length of the transmission path (e.g., the number of the processing elements PE1, PE2, and PE3 arranged in one row, the controller 130 may set the delay time DT to ‘1’ or a number greater than ‘1’.

When the length of the input data (e.g., the number of processing elements required to process the data) is equal to or less than the length of the transmission path (e.g., the number of the processing elements PE1, PE2, and PE3 arranged in one row), the controller 130 may set the delay time DT to ‘0’.

In operation S130, the controller 130 of the processor 100 may delay the input data and the kernel data by the delay time DT, and may control the processing elements PE1, PE2, and PE3 to perform an operation.

When the length of the input data (e.g., the number of processing elements required to process the data) is greater that the length of the transmission path (e.g., the number of the processing elements PE1, PE2, and PE3 arranged in one row), the first and second processing elements PE1 and PE2 may delay the input data ID by ‘1’ or more operation cycles, and the kernel data memory 110 may delay the kernel data KD by ‘1’ or more operation cycles.

When the length of the input data (e.g., the number of processing elements required to process the data) is equal to or less than the length of the transmission path (e.g., the number of the processing elements PE1, PE2, and PE3 arranged in one row), the first and second processing elements PE1 and PE2 do not delay the input data ID, and the kernel data memory 110 does not delay the kernel data KD.

For example, delaying the input data ID by the delay time DT may be performed by the first and second processing elements PE1 and PE2. Each of the first and second processing elements PE1 and PE2 may delay the received command CMD and the input data ID by operation cycles corresponding to the delay time DT, and then may transfer the delayed command CMD and the delayed input data ID to the processing element PE2 or PE3 in the subsequent column.

For example, delaying the kernel data KD by the delay time DT may be performed by the kernel data memory 110. The kernel data memory 110 may transfer the kernel data KD to a specific column, and may transfer the kernel data KD to the subsequent column after operation cycles corresponding to the delay time DT elapse.

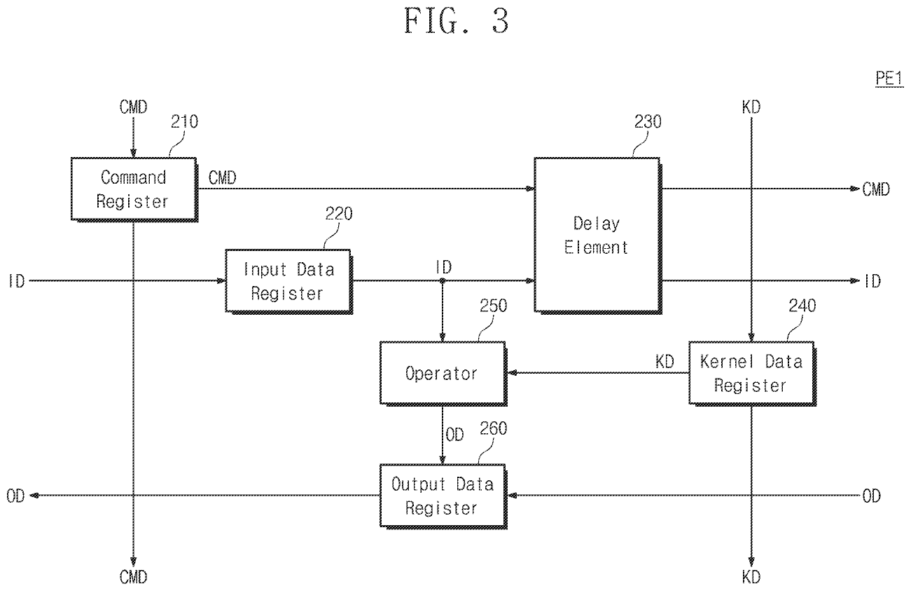

FIG. 3 illustrates the first processing element PE1 according to an embodiment of the present disclosure. Referring to FIGS. 1 and 3, the first processing element PE1 may include a command register 210, an input data register 220, a delay element 230, a kernel data register 240, an operator 250, and an output data register 260.

The command register 210 may store the command CMD transferred from the controller 130 or the first processing element PE1 in the previous row. The command register 210 may transfer the stored command to the delay element 230. The command register 210 of the first processing elements PE1 in the first to (m−1)-th rows may transfer the command CMD to the first processing elements PE1 in the subsequent row.

The input data register 220 may store input data ID transferred from the data memory 120. The input data register 220 may transfer the stored input data ID to the delay element 230 and the operator 250.

The delay element 230 may correspond to the delay element D of FIG. 1. The delay element 230 may store the command CMD transferred from the command register 210 and the input data ID transferred from the input data register 220. The delay element 230 may delay and output the command CMD and the input data ID by operation cycles determined by the delay time DT. The command CMD and input data ID output from the delay element 230 may be transferred to the second processing element PE2 in the subsequent column.

The kernel data register 240 may store the kernel data KD transferred from the kernel data memory 110 or the first processing element PE1 in the previous row. The kernel data register 240 may transfer the stored kernel data KD to the operator 250. The kernel data register 240 of the first processing elements PE1 in the first to (m−1)-th rows may transfer the stored kernel data KD to the first processing element PE1 in the subsequent row.

The operator 250 may receive input data ID from the input data register 220, and may receive kernel data KD from the kernel data register 240. The operator 250 may generate the output data OD by performing an operation indicated by the command CMD with respect to the input data ID and the kernel data KD. The operator 250 may transfer the output data OD to the output data register 260.

The output data register 260 may store the output data OD transferred from the operator 250 or the output data OD transferred from the second processing element PE2 in the subsequent column. The output data register 260 may transfer the stored output data OD to the data memory 120.

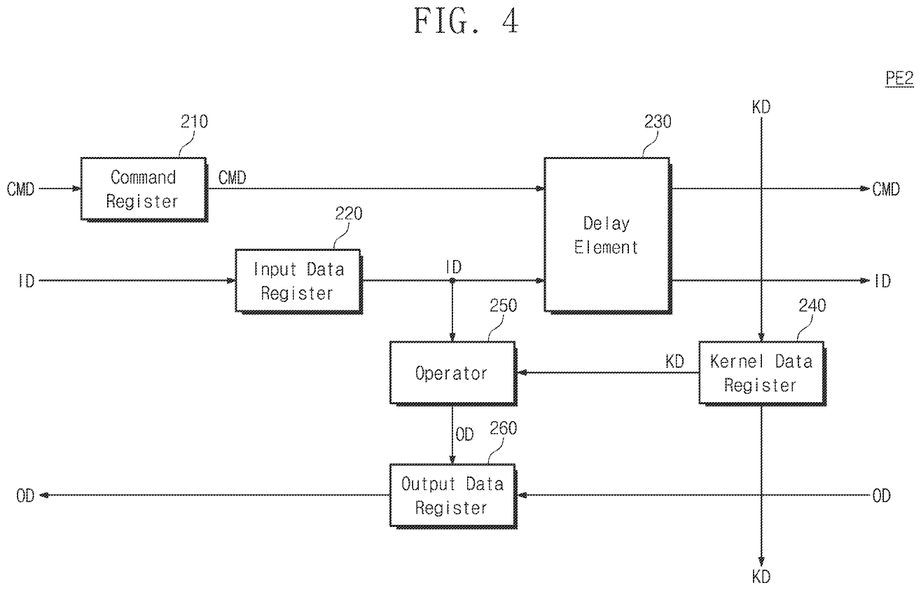

FIG. 4 illustrates the second processing element PE2 according to an embodiment of the present disclosure. Referring to FIGS. 1 and 4, the second processing element PE2 may include the command register 210, the input data register 220, the delay element 230, the kernel data register 240, the operator 250, and the output data register 260.

The command register 210 may store the command CMD transferred from the first processing element PE1 or the second processing element PE2 in the previous row. The command register 210 may transfer the stored command to the delay element 230. The command register 210 of the second processing elements PE2 of the first to (m−1)-th rows may transfer the command CMD to the second processing elements PE2 in the subsequent row.

The input data register 220 may store the input data ID transferred from the first processing element PE1 or the second processing element PE2 in the previous row. The input data register 220 may transfer the stored input data ID to the delay element 230 and the operator 250.

The delay element 230 may store the command CMD transferred from the command register 210 and the input data ID transferred from the input data register 220. The delay element 230 may delay and output the command CMD and the input data ID by operation cycles determined by the delay time DT. The command CMD and the input data ID output from the delay element 230 may be transferred to the second processing element PE2 or the third processing element PE3 in the subsequent column.

The kernel data register 240 may store the kernel data KD transferred from the kernel data memory 110 or the second processing element PE2 in the previous row. The kernel data register 240 may transfer the stored kernel data KD to the operator 250. The kernel data register 240 of the second processing elements PE2 in the first to (m−1)-th rows may transfer the stored kernel data KD to the second processing element PE2 in the subsequent row.

The operator 250 may receive the input data ID from the input data register 220, and may receive the kernel data KD from the kernel data register 240. The operator 250 may generate the output data OD by performing an operation indicated by the command CMD with respect to the input data ID and the kernel data KD. The operator 250 may transfer the output data OD to the output data register 260.

The output data register 260 may store the output data OD transferred from the operator 250 or the output data OD transferred from the second processing element PE2 or the third processing element in the subsequent column. The output data register 260 may transfer the stored output data OD to the first processing element PE1 or the second processing element PE2 in the previous column.

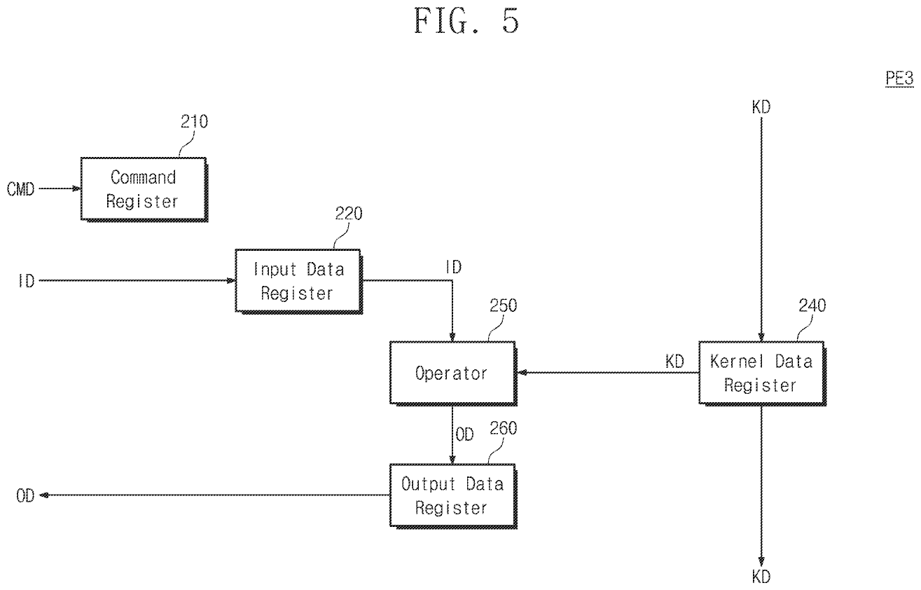

FIG. 5 illustrates the third processing element PE3 according to an embodiment of the present disclosure. Referring to FIGS. 1 and 5, the third processing element PE3 may include the command register 210, the input data register 220, the kernel data register 240, the operator 250, and the output data register 260.

The command register 210 may store the command CMD transferred from the second processing element PE2 in the previous row. The input data register 220 may store the input data ID transferred from the second processing element PE2 in the previous row. The input data register 220 may transfer the stored input data ID to the operator 250.

The kernel data register 240 may store the kernel data KD transferred from the kernel data memory 110 or the third processing element PE3 in the previous row. The kernel data register 240 may transfer the stored kernel data KD to the operator 250. The kernel data register 240 of the third processing elements PE3 in the first to (m−1)-th rows may transfer the stored kernel data KD to the third processing element PE3 in the subsequent row.

The operator 250 may receive the input data ID from the input data register 220, and may receive the kernel data KD from the kernel data register 240. The operator 250 may generate the output data OD by performing an operation indicated by the command CMD with respect to the input data ID and the kernel data KD. The operator 250 may transfer the output data OD to the output data register 260.

The output data register 260 may store the output data OD transferred from the operator 250. The output data register 260 may transfer the stored output data OD to the second processing element PE2 in the previous column.

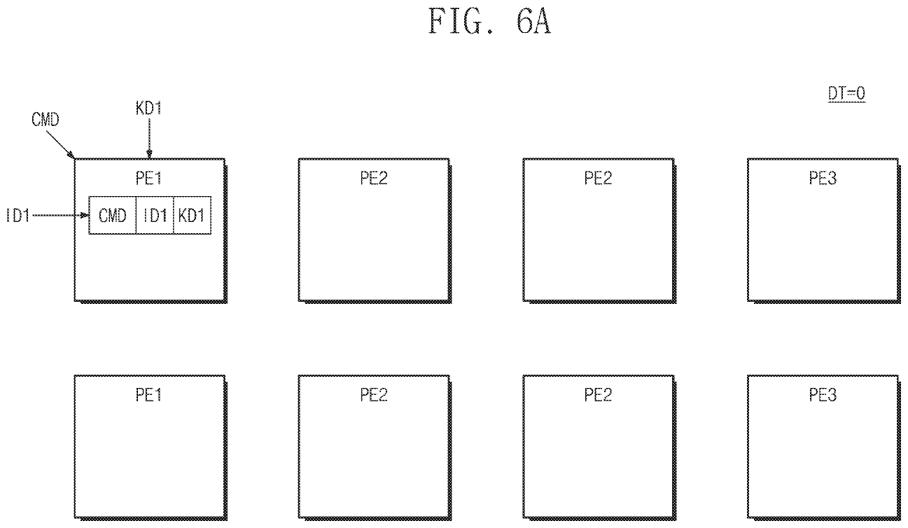

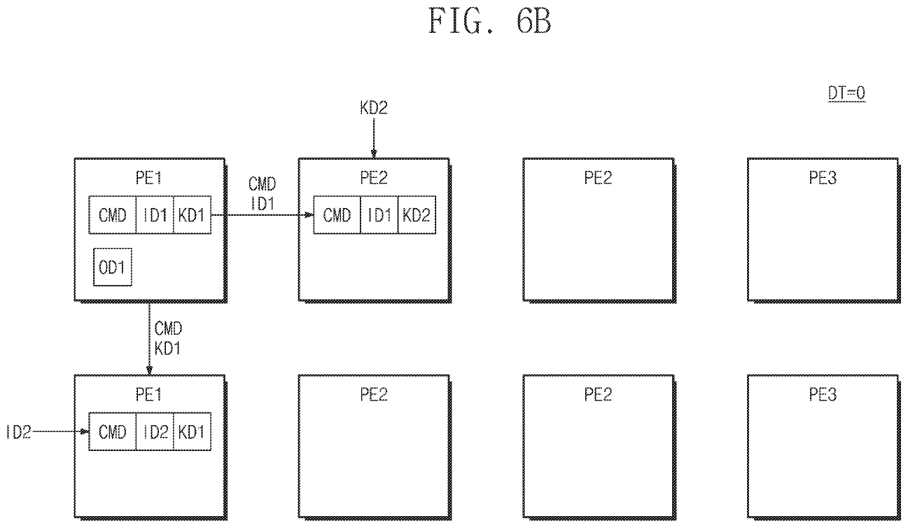

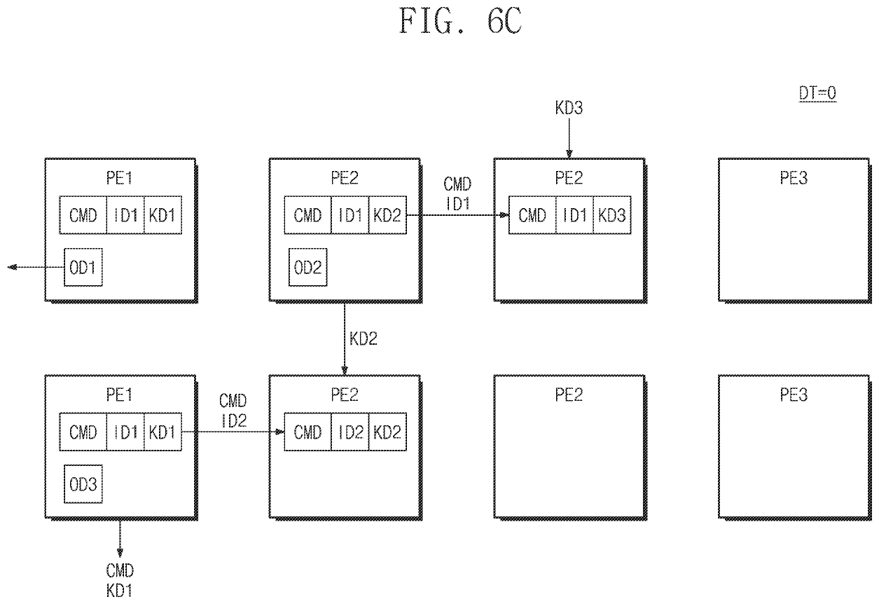

FIGS. 6A, 6B, and 6C illustrate examples in which the processing elements PE1, PE2, and PE3 operate when the delay time DT is ‘0’ (DT=0). Referring to FIGS. 1, 3, 4, 5, and 6A, in a first operation cycle, the first processing element PE1 in the first row may receive the command CMD, first input data ID1, first kernel data KD1.

The command CMD may be received from the controller 130. The first kernel data KD1 may be received from the kernel data memory 110. The first input data ID1 may be received from the data memory 120.

Referring to FIGS. 1, 3, 4, 5, and 6B, in a second operation cycle, the first processing element PE1 in the first row may generate first output data OD1 by performing an operation indicated by the command CMD with respect to the first input data ID1 and the first kernel data KD1. The first processing element PE1 in the first row may transfer the command CMD and the first kernel data KD1 to the first processing element PE1 in the second row.

The first processing element PE1 in the second row may receive the command CMD, second input data ID2, and the first kernel data KD1. The command CMD may be received from the first processing element PE1 in the first row. The first kernel data KD1 may be received from the first processing element PE1 in the first row. The second input data ID2 may be received from the data memory 120.

Since the delay time DT is ‘0’ (DT=0), the first processing element PE1 in the first row may output the command CMD and the first input data ID1 to the second processing element PE2 in the first row and the second column without delaying. In addition, the kernel data memory 110 may transfer second kernel data KD2 to the second processing element PE2 in the first row and the second column without delaying. The second processing element PE2 in the first row and the second column may receive the command CMD, the first input data ID1, and the second kernel data KD2. The command CMD and the first input data ID1 may be received from the first processing element PE1 in the first row. The second kernel data KD2 may be received from the kernel data memory 110.

Referring to FIGS. 1, 3, 4, 5, and 6C, in a third operation cycle, the second processing element PE2 in the first row and the second column may generate second output data OD2 by performing an operation indicated by the command CMD with respect to the first input data ID1 and the first kernel data KD1. The second processing element PE2 in the first row and the second column may transfer the second kernel data KD2 to the second processing element PE2 in the second row and the second column.

Since the delay time DT is ‘0’ (DT=0), the second processing element PE2 in the first row and the second column may transfer the command CMD and the first input data ID1 to the second processing element PE2 in the first row and the third column. In addition, the kernel data memory 110 may transfer third kernel data KD3 to the second processing element PE2 in the first row and the third column without delaying. The second processing element PE2 in the first row and third column may receive the command CMD, the first input data ID1, and the third kernel data KD3. The command CMD may be received from the second processing element PE2 in the first row and the second column. The third kernel data KD3 may be received from the kernel data memory 110.

The first processing element PE1 in the first row may output the first output data OD1 to the data memory 120.

The first processing element PE1 in the second row may generate third output data OD3 by performing an operation indicated by the command CMD with respect to the second input data ID2 and the first kernel data KD1. The first processing element PE1 in the second row may transfer the first kernel data KD1 to the first processing element PE1 (not illustrated) in the third row.

Since the delay time DT is ‘0’ (DT=0), the first processing element PE1 in the second row may transfer the command CMD and the second input data ID2 to the second processing element PE2 in the second row and the second column.

The second processing element PE2 in the second row and second column may receive the command CMD, the second kernel data KD2, and the second input data ID2. The command CMD and the second input data ID2 may be received from the first processing element PE1 in the second row. The second kernel data KD2 may be received from the second processing element PE2 in the first row and the second column.

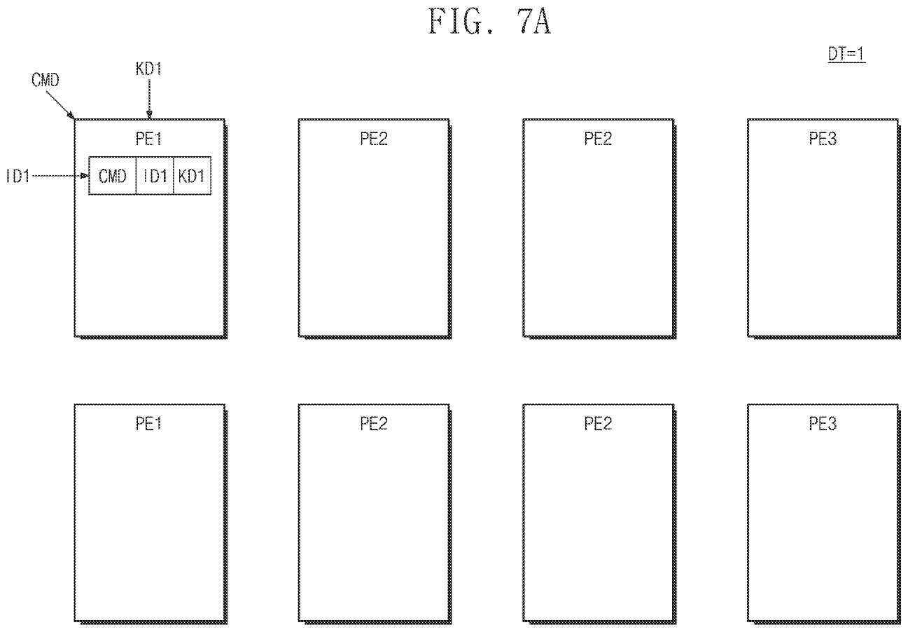

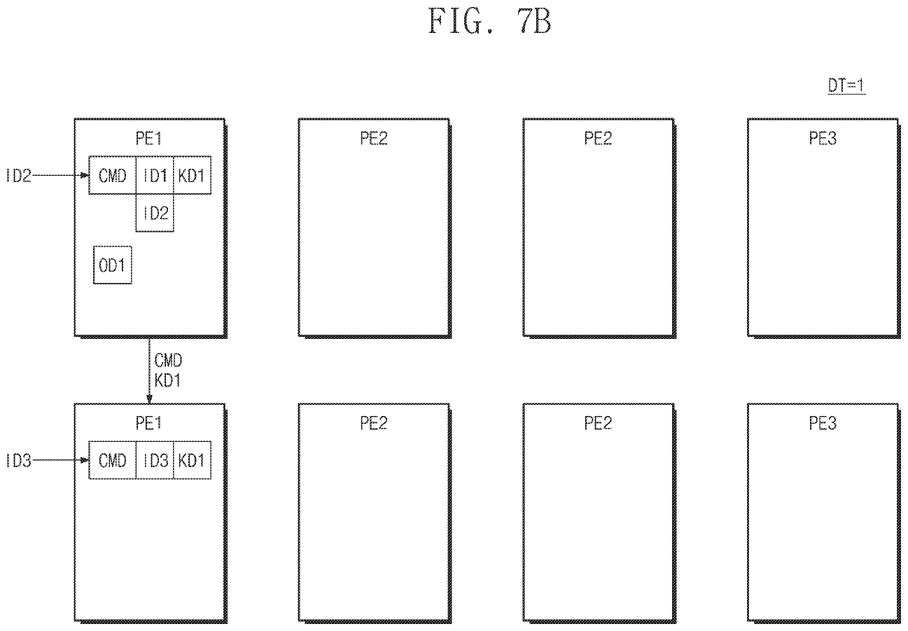

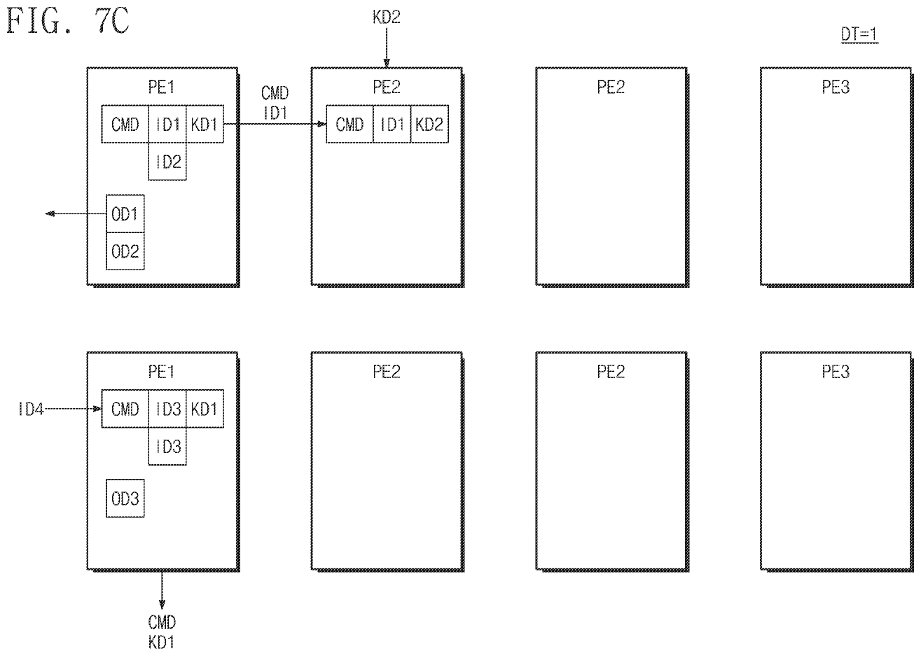

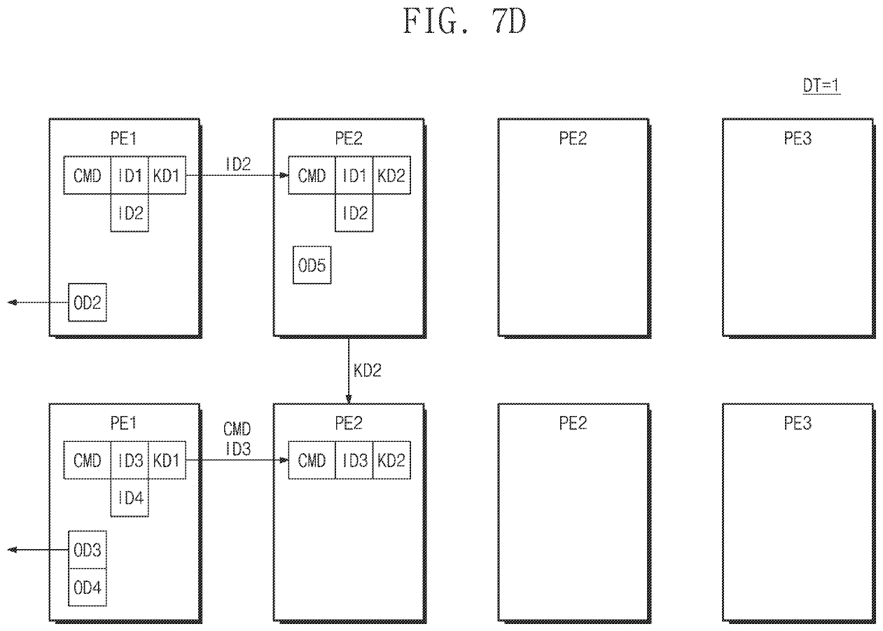

FIGS. 7A, 7B, 7C, and 7D illustrate examples in which the processing elements PE1, PE2, and PE3 operate when the delay time DT is ‘1’ (DT=1). Referring to FIGS. 1, 3, 4, 5 and 7A, in a first operation cycle, the first processing element PE1 in the first row may receive the command CMD, the first input data ID1, and the first kernel data KD1.

The command CMD may be received from the controller 130. The kernel data KD1 may be received from the kernel data memory 110. The first input data ID1 may be received from the data memory 120.

Referring to FIGS. 1, 3, 4, 5, and 7B, in a second operation cycle, the first processing element PE1 in the first row may generate the first output data OD1 by performing an operation indicated by the command CMD with respect to the first input data ID1 and the first kernel data KD1. The first processing element PE1 in the first row may transfer the command CMD and the first kernel data KD1 to the first processing element PE1 in the second row.

The first processing element PE1 in the second row may receive the command CMD, the second input data ID2, and the first kernel data KD1. The command CMD may be received from the first processing element PE1 in the first row. The first kernel data KD1 may be received from the first processing element PE1 in the first row. The second input data ID2 may be received from the data memory 120.

The first processing element PE1 in the first row may receive the second input data ID2. The second input data ID2 may be received from the data memory 120. Since the delay time DT is ‘1’ (DT=1), the first processing element PE1 in the first row may delay the command CMD and the first input data ID1 without transferring the command CMD and the first input data ID1 to the second processing element PE2 in the first row and the second column.

Referring to FIGS. 1, 3, 4, 5, and 7C, in a third operation cycle, the first processing element PE1 in the first row may generate the second output data OD2 by performing an operation indicated by the command CMD with respect to the second input data ID2 and the first kernel data KD1. The first processing element PE1 in the first row may transfer the first output data OD1 to the data memory 120.

Since the command CMD and the first input data ID1 are received and then delayed by the delay time DT, the first processing element PE1 in the first row may transfer the command CMD and the first input data ID1 to the second processing element PE2 in the first row and the second column. Since the delay time DT elapses after transferring the first kernel data KD1 to the first processing element PE1 in the first row, the kernel data memory 110 may transfer the second kernel data KD2 to the second processing element PE2 in the first row and the second column. The second processing element PE2 in the first row and the second column may receive the command CMD, the first input data ID1, and the second kernel data KD2. The command CMD and the first input data ID1 may be received from the first processing element PE1 in the first row. The second kernel data KD2 may be received from the kernel data memory 110.

The first processing element PE1 in the second row may generate the third output data OD3 by performing an operation indicated by the command CMD with respect to the third input data ID3 and the first kernel data KD1. The first processing element PE1 in the second row may transfer the command CMD and the first kernel data KD1 to the first processing element PE1 (not illustrated) in the third row.

The first processing element PE1 in the second row may receive fourth input data ID4 from the data memory 120. Since the delay time DT is ‘1’ (DT=1), the first processing element PE1 in the second row may delay the command CMD and the second input data ID2 without transferring the command CMD and the second input data ID2 to the second processing element PE2 in the second row and the second column.

Referring to FIGS. 1, 3, 4, 5, and 7D, in a fourth operation cycle, the first processing element PE1 in the first row may transfer the second output data OD2 to the data memory 120. Since the delay time DT elapses after the second input data ID2 is received, the first processing element PE1 in the first row may transmit the second input data ID2 to the second processing element PE2 in the first row and the second column. The second processing element PE2 in the first row and the second column may receive the second input data ID2 from the first processing element PE1 in the first row. The second processing element PE2 in the first row and the second column may generate the fifth output data OD5 by performing an operation indicated by the command CMD with respect to the first input data ID1 and the second kernel data KD2. The second processing element PE2 in the first row and the second column may transfer the second kernel data KD2 to the second processing element PE2 in the second row and the second column.

The first processing element PE1 in the second row may generate the fourth output data OD4 by performing an operation indicated by the command CMD with respect to the third input data ID3 and the first kernel data KD1. The first processing element PE1 in the second row may transfer the third output data OD3 to the data memory 120.

Since the command CMD and the third input data ID3 are received and then delayed by the delay time DT, the first processing element PE1 in the second row may transfer the command CMD and the third input data ID3 to the second processing element PE2 in the second row and the second column.

The second processing element PE2 in the second row and second column may receive the command CMD, the second input data ID2, and the second kernel data KD2. The command CMD and the second input data ID2 may be received from the first processing element PE1 in the second row. The second kernel data KD2 may be received from the second processing element PE2 in the first row and the second column.

As described above, when the delay time DT is ‘1’, each of the processing elements PE1, PE2, and PE3 may perform operations during two operation cycles. When the delay time DT is ‘i’ (‘i’ is a positive integer), each of the processing elements PE1, PE2, and PE3 may perform operations during i+1 operation cycles. Accordingly, a size of input data that the processor 100 may operate may be adaptively adjusted.

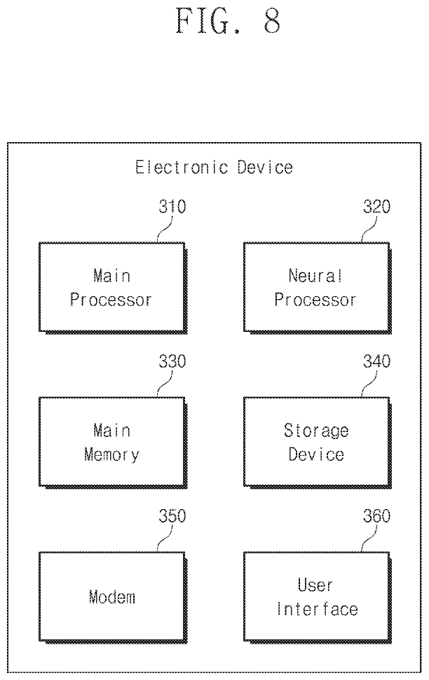

FIG. 8 illustrates an electronic device 300 according to an embodiment of the present disclosure. Referring to FIG. 8, the electronic device 300 may include a main processor 310, a neural processor 320, a main memory 330, a storage device 340, a modem 350, and a user interface 360.

The main processor 310 may include a central processing unit or an application processor. The main processor 310 may execute an operating system and applications using the main memory 330. The neural processor 320 may perform a neural network operation (e.g., a convolution operation) in response to a request from the main processor 310. The neural processor 320 may include the processor 100 described with reference to FIG. 1.

The main memory 330 may be an operational memory of the electronic device 300. The main memory 330 may include a random access memory. The storage device 340 may store original data of the operating system and applications executed by the main processor 310, and may store data generated by the main processor 310. The storage device 340 may include a nonvolatile memory.

The modem 350 may perform wireless or wired communication with an external device. The user interface 360 may include a user input interface for receiving information from a user, and a user output interface for outputting information to the user.

In the above-described embodiments, components according to the present disclosure are described using terms such as first, second, third, etc. However, terms such as first, second, and third are used to distinguish components from one another, and do not limit the present disclosure. For example, terms such as first, second, third, etc., do not imply numerical meaning in any order or in any form.

In the above-described embodiments, components according to embodiments of the present disclosure are illustrated using blocks. The blocks may be implemented as various hardware devices such as an Integrated Circuit (IC), an Application Specific IC (ASIC), a Field Programmable Gate Array (FPGA), and a Complex Programmable Logic Device (CPLD), a firmware running on hardware devices, software such as an application, or a combination of hardware devices and software. Further, the blocks may include circuits composed of semiconductor elements in the IC or circuits registered as IP (Intellectual Property).

According to an embodiment of the present disclosure, the processor may adaptively adjust an operation scale by adjusting a delay time in the processing elements. Accordingly, a systolic array processor having improved flexibility and a method of operating the systolic array processor are provided.

The contents described above are specific embodiments for implementing the present disclosure. The present disclosure will include not only the embodiments described above but also embodiments in which a design is simply or easily capable of being changed. In addition, the present disclosure may also include technologies easily changed to be implemented using embodiments. Therefore, the scope of the present disclosure is not limited to the described embodiments but should be defined by the claims and their equivalents.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A processor comprising:
processing elements;
a kernel data memory configured to provide a kernel data set to the processing elements;
a data memory configured to provide an input data set to the processing elements; and
a controller configured to provide commands to the processing elements, and
wherein a first processing element among the processing elements delays a first command received from the controller and first input data received from the data memory for a delay time, and then transfers the delayed first command and the delayed first input data to a second processing element, and
wherein the controller adjusts the delay time.

2. The processor of claim 1, wherein the second processing element delays the first command and the first input data received from the first processing element for the delay time, and then transfers the delayed first command and the delayed first input data to a third processing element.

3. The processor of claim 2, wherein a fourth processing element of the processing elements receives the first command from the first processing element, receives second input data from the data memory, and delays the first command and the second input data and then transfers the delayed first command and the delayed second input data to a fifth processing element.

4. The processor of claim 3, wherein the fifth processing element delays the first command and the second input data received from the fourth processing element for the delay time and then transfers the delayed first command and the delayed second input data to a sixth processing element.

5. The processor of claim 2, wherein the kernel data memory provides first kernel data to the first processing element, and provides second kernel data to the second processing element after the delay time elapses.

6. The processor of claim 1, wherein the first command and the first input data are transferred from the second processing element to a third processing element through at least one processing element, and
wherein the third processing element performs an operation based on the first command and the first input data, and then does not transfer the first command and the first input data to another processing element.

7. The processor of claim 1, wherein the first processing element delays a second command received from the controller and a second input data received from the data memory for the delay time and then transfers the delayed second command and the delayed second input data to the second processing element.

8. The processor of claim 1, wherein the first processing element generates first output data by performing an operation based on the first command with respect to first kernel data received from the kernel data memory and the first input data, and transfers the first output data to the data memory without delaying.

9. The processor of claim 8, wherein the second processing element generates second output data by performing an operation based on the first command with respect to second kernel data received from the kernel data memory and the first input data, and transfers the second output data to the first processing element without delaying.

10. A method of operating a processor including a plurality of processing elements arranged in rows and columns, the method comprising:
identifying a length of input data;
calculating a delay time based on the length of the input data and a length of a transmission path of the plurality of processing elements; and
performing an operation while delaying the input data and kernel data by the delay time in at least some of the plurality of processing elements.

11. The method of claim 10, wherein the identifying of the length of the input data includes identifying the number of processing elements required to process data input to processing elements in one row of the input data.

12. The method of claim 11, wherein the length of the transmission path of the processing elements is the number of processing elements arranged in one row of the plurality of processing elements.

13. The method of claim 12, wherein, when the number of processing elements required to process the data is greater than the number of processing elements arranged in the one row, the delay time is 1 or more.

14. The method of claim 12, wherein, when the number of processing elements required to process the data is less than or equal to the number of processing elements arranged in the one row, the delay time is ‘0’.

15. The method of claim 10, wherein the delay time is counted as the number of operation cycles of the plurality of processing elements.
